(19) United States
(12) Patent Application Publication
(10) Pub. No.: US 2012/0327345 A1
(43) Pub. Date: Dec. 27, 2012

(54) DISPLAY PANEL AND PROCESS FOR PRODUCTION THEREOF

(75) Inventors: Katsuki Inoue, Osaka (JP); Kazuki Kobayashi, Osaka (JP)

(73) Assignee: Sharp Kabushiki Kaisha, Osaka (JP)

(21) Appl. No.: 13/583,131

(22) PCT Filed: Dec. 3, 2010
(86) PCT No.: PCT/JP2010/071697

§ 371 Date: Sep. 6, 2012

(30) Foreign Application Priority Data
Mar. 12, 2010 (JP) 2010-056579

(51) Int. Cl. G02F 1/1337; H01J 9/00; G02F 1/1333

(52) U.S. Cl. 349/123; 349/122; 445/24

(57) ABSTRACT

The present invention provides a display panel in which a defect such as a depressed portion formed on the glass substrate is restored, and a damage on an alignment layer due to the restoration is sufficiently suppressed, so that occurrence of display poor is prevented. The display panel of the present invention comprises: a pair of substrates; a display element disposed between the substrates; and a functional film disposed on a surface facing the display element of at least one of the substrates, the functional film being formed from a material having a photosensitive group, at least one of the substrates having a depressed portion on its surface and the depressed portion being filled with a cured product of an ultraviolet-curable resin, and the cured product having been formed by curing the ultraviolet-curable resin with ultraviolet rays at a wavelength of 400 nm or longer.

### TECHNICAL FIELD

The present invention relates to a display panel and a process for production thereof. The present invention specifically relates to a display panel in which damages such as a depressed portion defect formed on its glass substrate are repaired, and a process for production thereof.

### BACKGROUND ART

Display panels, for example, a display panel in which a pair of glass substrates sandwich a display element, are focused on as display panels achieving light weight, thin profile, and low power consumption. These panels are used in mobile applications and used for various monitors and large-size televisions, and thus are now indispensable to social life and in business.

Such a display panel has a functional film formed thereon; for example, in the case of liquid crystal display panels, an alignment layer, which is used for adjusting the alignment of liquid crystal molecules, is formed on a glass substrate, and other components such as an electrode are formed. In the production process thereof, the quality of components of display panels and a process are strictly controlled. With respect to glass substrates, precise inspection is performed so as to check the presence of defects and restoration is performed when a defect is found. The restoration step contributes to cost reduction owing to improved yield and improved quality. Thus, importance of the restoration is being greater as the display panels are being made larger and being made with higher quality.

Various restoration methods are proposed which are used in production of conventional display panels if a defect or loss occurs on a glass substrate for some reason (e.g. see Patent Literatures 1 to 4). For example, one method is disclosed in which, if a defect (depressed portion) is present on a plane glass substrate, an ultraviolet-curable (UV-curable) resin is filled into the depressed portion and then cured to restore the defect (e.g. see Patent Literature 4).

If the ultraviolet-curable resin is cured by light with a wavelength shorter than 350 nm, the light has a bad effect on a liquid crystal material inside a liquid crystal display. Thus, it is disclosed that light is applied to the inside of a depressed portion through a cut filter which blocks light with a wavelength shorter than 350 nm, so that the material substance inside the depressed portion is polymerized to be a cured ultraviolet-curable resin. In contrast, a photo initiating material of the resin used for restoration does not absorb light with a wavelength of 400 nm or longer. Thus, ultraviolet rays to be used are preferably at a wavelength of 350 nm or longer and 400 nm or shorter. In other words, as mentioned above, reduction in bad influence on a liquid crystal material and optimization of a state of a cured ultraviolet-curable resin are desired in this restoration method.

### CITATION LIST

### Patent Literature

Patent Literature 1: JP 2002-196318 A
Patent Literature 2: JP 2003-270661 A
Patent Literature 3: JP 2006-206372 A
Patent Literature 4: WO 2009/004886

### SUMMARY OF INVENTION

### Technical Problem

As mentioned above, production of a display panel includes a step of restoring a glass substrate. A defect on a glass substrate causes deterioration in the display quality of a display panel even if the defect is a slight one. In order to effectively use such a glass substrate having a defect without any problem, the restoring step is an essential one. In particular, involved in the fact that display panels are being made larger, the importance of quality control for the purpose of improving yield and quality is being greater.

The step of restoring a glass substrate requires not only restoration of a defect portion of the glass substrate but also sufficient prevention of problems due to the restoration. In a conventional method of restoring a liquid crystal display panel, bad influence on a liquid crystal material inside the liquid crystal display is suppressed by filling a defect such as a depressed portion on a glass substrate to make the substrate smooth and, in the restoring step, optimizing the wavelength range of ultraviolet rays applied so as to cure an ultraviolet-curable resin.

However, a problem in optimizing the application area of ultraviolet rays is to suppress bad influence on a liquid crystal material. The liquid crystal material is not the only thing to be damaged, and other layers formed on the substrate are also affected. In particular, an alignment layer (functional film), which is formed by a step of exposing the alignment layer to light by a photo-alignment method, is found to be damaged by light application in the restoring step. On the other hand, a suitable light-curable resin composition to be filled into a depressed portion on a glass substrate is one containing a photo initiator which absorbs light within a predetermined wavelength range. Thus, in light application of the restoring step, there are a wavelength range which is optimum for curing a light-curable resin composition by an effect of a photo initiator to fill a depressed portion defect and a wavelength range which gives a damage on an alignment layer, and therefore the wavelength range is required to be selected in consideration of these facts. Problems on the alignment layer have an influence on alignment control of liquid crystal molecules to cause poor display, resulting in a failure to maintain excellent display quality. In order to improve properties such as a viewing angle of a liquid crystal display panel, multi-domain alignment is performed in which an alignment layer in one pixel is divided into multiple alignment directions. Especially in such a form, damages on the alignment layer have a greater influence.

In restoration of a glass substrate with such an alignment layer formed thereon, the conventional techniques disclose no influence on the alignment layer upon the restoration, and thus the technique shall be improved in this respect.

The present invention is devised under the aforementioned situation, and aims to provide a display panel in which defects such as a depressed portion formed on a glass substrate is restored and damages on a functional film due to the restoration is sufficiently suppressed so that poor display is prevented.

### Solution to Problem

The present inventors have performed various studies about a restoring step which is performed when a defect such as a depressed portion is found on a glass substrate and a display panel produced through such a step and, as a result, they have focused on the fact that light such as ultraviolet rays 151 (see FIG. 6) for curing a light-curable resin which is used for restoring a defect such as a depressed portion affects not only a liquid crystal material but also a functional film formed from a material having a functional group for photo-alignment. Then, the inventors have found that the functional film is damaged by light within a predetermined wavelength range, especially by ultraviolet rays with a wavelength of not shorter than 350 nm and shorter than 400 nm (hereinafter, also referred to as a wavelength of 350 to 400 nm), so that the light-curable resin for restoring a defect such as a depressed portion is required to be cured by a wavelength of 400 nm or longer as shown in FIG. 1. In particular, an alignment layer used in multi-domain alignment is more greatly damaged within a wavelength range of 350 to 400 nm. Further, the present inventors have found that a photo initiator for curing a light-curable resin to be used for restoring a defect particularly preferably absorbs light with a wavelength of 430 nm or shorter because such an initiator enables to sufficiently cure the light-curable resin to be used for restoring a defect by applying light of 400 nm or longer and 430 nm or shorter. Finally, the present inventors have arrived at a solution to the above problems and completed the present invention.

In other words, the present invention relates to a display panel, comprising: a pair of substrates; a display element disposed between the substrates; and a functional film disposed on a surface facing the display element of at least one of the substrates, the functional film being formed from a material having a photosensitive group, at least one of the substrates having a depressed portion on its surface and the depressed portion being filled with a cured product of an ultraviolet-curable resin, and the cured product having been formed by curing the ultraviolet-curable resin with ultraviolet rays at a wavelength of 400 nm or longer.

The substrate is commonly a transparent substrate, preferably a glass substrate. The depressed portion formed on the substrate surface is a defect itself formed on the glass substrate, such as a damage or a dent, or a depressed portion formed by restoring the above defects, or contamination by air bubbles or foreign matter. The depressed portion is a defect which is formed on a glass substrate previously or a defect formed in the process of producing a liquid crystal panel. The size, number, and shape of the depressed portion are not limited.

A display panel wherein a display element is sandwiched between a pair of glass substrates and a functional film is formed on the side of the display element of at least one of the substrates, may be in a form that a restoring step is performed on the glass substrate after the step of sandwiching as mentioned above, or may be in a form that a restoring step is performed on the glass substrate itself with the functional film formed thereon before the step of sandwiching as mentioned above. In either form, the effects of the present invention can be exerted.

The present invention also aims to perform a restoring step while suppressing a damage on the functional film formed on the glass substrate when restoring a depressed portion on the glass substrate. Therefore, the present invention is preferably applied to restoration of a depressed portion formed on an area other than the area where the functional film is formed on the glass substrate. For example, the functional film is formed on the side of the display element of the glass substrate, so that the present invention is preferably applied to restoration of a depressed portion on the side opposite to the display element (outside) of the glass substrate.

One preferable form of the display panel of the present invention is that the ultraviolet-curable resin is a resin composition containing a photo initiator that absorbs ultraviolet rays with a wavelength of 430 nm or shorter. The ultraviolet-curable resin (light-curable resin) is photo-cured by a photo initiator in general, and the photo initiator used for a light-curable resin for restoring a defect is preferably one absorbing ultraviolet rays with a wavelength of 430 nm or shorter. Such an initiator is particularly preferable in the optical resolution process. Therefore, in the present invention, one which absorbs ultraviolet rays with a wavelength of 430 nm or shorter, preferably a wavelength of 400 nm or longer and 430 nm or shorter, and which served as a photo initiator is used.

A cured product of the ultraviolet-curable resin (cured product of the light-curable resin) is preferably in a form that it is produced by curing the resin by ultraviolet rays with a wavelength of 430 nm or shorter. For example, the resin is preferably (meth)acrylic resin, and it can be photo-cured within the wavelength range of the present invention when used together with the photo initiator. The photo initiator is also preferably one used for light-curing of (meth) acrylic resin.

The present invention also relates to a process for producing a display panel comprising a pair of substrates, a display element disposed between the substrates, and a functional film disposed on a surface facing the display element of at least one of the substrates, wherein the functional film is formed from a material having a photosensitive group, and at least one of the substrates has a depressed portion on its surface, the method comprising the steps of: filling an ultraviolet-curable resin into the depressed portion; and light-curing the ultraviolet-curable resin by applying ultraviolet rays at a wavelength of 400 nm or longer to the resin. Further, the ultraviolet-curable resin is preferably irradiated with ultraviolet rays with a wavelength of 430 nm or shorter to be cured.

One preferable form of the present invention includes a defect-checking process and a defect-restoring process on the substrate (transparent substrate, glass substrate). The defect-restoring process includes a step of filling an ultraviolet-curable resin into the depressed portion defect and a photo-curing step of applying ultraviolet rays with the above predetermined wavelength range. Before the step of filling an ultraviolet-curable resin, the process may include, for example, a step of shaving a defect portion off to form a depressed portion.

In the application of the ultraviolet rays, ultraviolet rays with a wavelength of 400 nm or longer (preferably 400 nm or longer and 430 nm or shorter; hereinafter, also referred to as 400 to 430 nm). As long as the effects of the present invention are exerted, ultraviolet rays with other wavelength ranges may also be included. Examples of preferable forms include: (1) a form in which the maximum value of the specific intensity of ultraviolet rays within a wavelength range of 350 nm or longer and shorter than 400 nm which cause a damage on an alignment layer is lower than the maximum value of the specific intensity of ultraviolet rays within a wavelength range of 400 to 430 nm; and (2) a form in which the maximum value of the specific intensity of ultraviolet rays within a wavelength range of 350 nm or longer and shorter than 400 nm is 50% or lower (preferably 30% or lower, more preferably 10% or lower) of the maximum value of the specific intensity of ultraviolet rays within a wavelength range of 400 to 430 nm.

Examples of a method for applying the ultraviolet rays include a method using an ultraviolet application device equipped with, for example, a filter cutting ultraviolet rays with a wavelength shorter than the lower limit of the predetermined wavelength range.

As one preferable form of the process for producing a display panel of the present invention, a form may be mentioned in which i-line rays in the ultraviolet rays applied to the ultraviolet-curable resin are cut in the light-curing step. The i-line rays are 365-nm ultraviolet rays. The form in which the i-line rays are cut is not limited to the form in which the i-line rays are perfectly cut, and forms are suitable in which the i-line rays are cut to the extent that the effects of the present invention are considered to be exerted. Preferable is a form in which the i-line rays are substantially perfectly cut (shielded). For example, use of items such as a cut filter enables to cut the i-line rays.

As one preferable form of the process for producing a display panel of the present invention, a form may be mentioned in which h-line rays are applied to the ultraviolet-curable resin in the light-curing step.

The h-line rays are 405-nm ultraviolet rays. In such a preferable form, in general, the light-curing step in the depressed-portion-defect-restoring process is performed by a method of using an ultraviolet-application device equipped with, for example, a filter that cuts ultraviolet rays with a wavelength shorter than the lower limit of the above predetermined wavelength range or by using an ultraviolet-application device that specifically and strongly emits ultraviolet rays with a predetermined wavelength range.

In the present invention, light may be applied only to a depressed portion defect area or may be applied to the whole substrate in the light application step of the defect-restoring process. In order to minimize a damage on an alignment layer, light is preferably applied only to a depressed portion defect area. In this case, generally, light is applied only to the depressed portion defect area and its vicinity, including a margin of error.

In the display panel and the process for production thereof of the present invention, a form is particularly preferable in which the display element is a liquid crystal layer and the functional film is an alignment layer. The display panel and the process for production thereof of the present invention are preferably a liquid crystal display panel and the process for production thereof, respectively.

Other configurations of the aforementioned display panel of the present invention and process for production thereof may be employed in appropriate combination, and are not particularly limited as long as the effects of the present invention are not inhibited. The aforementioned forms may be employed in appropriate combination as long as the combination is not beyond the spirit of the present invention.

### Advantageous Effects of Invention

The display panel of the present invention and the process for production thereof can provide a display panel in which a defect such as a depressed portion formed on the glass substrate is restored and occurrence of poor display is prevented by sufficiently suppressing a damage on an alignment layer by restoration.

### BRIEF DESCRIPTION OF DRAWINGS

FIG. 1 is a view showing a step of applying ultraviolet rays in Embodiment 1.

FIG. 2 is a schematic cross-sectional view showing a liquid crystal display panel of Embodiment 1.

FIG. 3 shows a graph of the wavelength range of a Hg—Xe lamp used in Embodiment 1.

FIG. 4 shows a graph of the spectrum of a cut filter used in Embodiment 1.

FIG. 5 shows a graph of the spectrum of a Hg—Xe lamp in combination with a cut filter, and a graph of the spectrum of a Hg—Xe lamp without a cut filter in Embodiment 1.

FIG. 6 is a view showing a step of applying ultraviolet rays in Comparative Example 1.

FIG. 7 shows a graph of the spectrum of a cut filter used in Comparative Example 1.

### DESCRIPTION OF EMBODIMENTS

The present invention will be mentioned in more detail in the following embodiments, but is not limited to these embodiments. The term “(meth) acrylic resin” herein means both methacrylic resin and acrylic resin.

### Embodiment 1

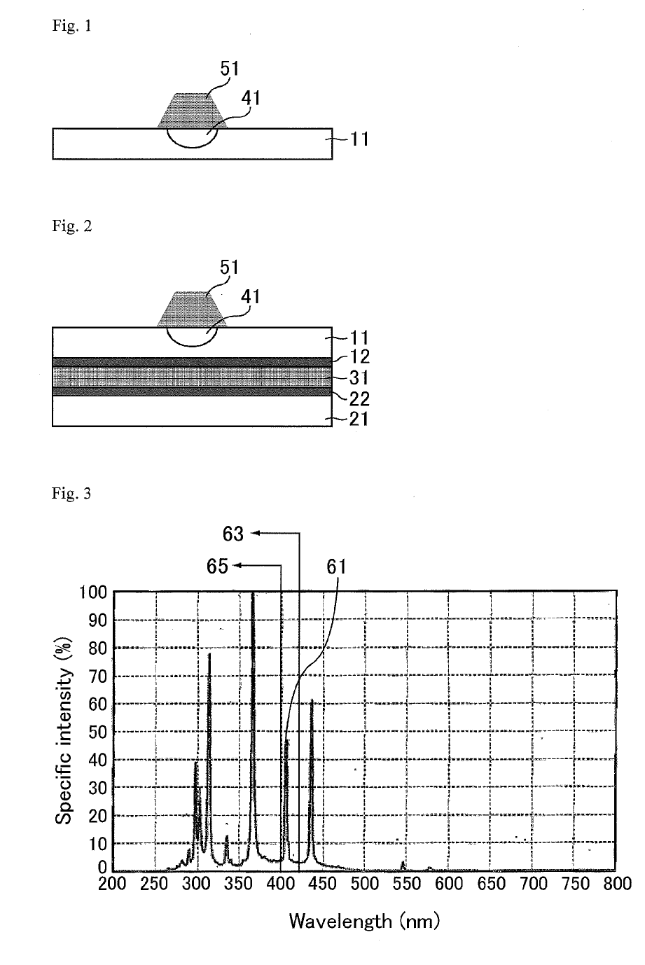

FIG. 1 is a view showing a step of applying ultraviolet rays in Embodiment 1.

FIG. 2 is a schematic cross-sectional view showing a liquid crystal display panel of Embodiment 1.

In Embodiment 1, a liquid crystal material 31 is sandwiched between a pair of glass substrates 11 and 21. Alignment layers 12 and 22 are disposed on the surfaces of the substrates 11 and 21, respectively, each on the side of the liquid crystal layer. Each glass substrate used in Embodiment 1 is a glass substrate used for a liquid crystal display panel. On the surface opposite to the liquid crystal material 31 of each of the glass substrates 11 and 21 may be disposed a polarizer film. A retardation film may be disposed between the polarizer films and the glass substrates 11 and 21. Further, a transparent electrode and/or a color filter (not shown) are disposed on the surface at the side of the liquid crystal material 31 of each of the glass substrates 11 and 21. In addition, a backlight (not shown) is commonly disposed on the backside (side opposite to the observer) of the polarizer film on the backside of the glass substrate 21. The liquid crystal layer (liquid crystal material) contains liquid crystal molecules having negative dielectric anisotropy. The alignment layer 12 and the alignment layer 22 align the liquid crystal molecules in directions substantially vertical to the film surfaces and orthogonal to each other, and they each are a light-alignment layer produced from a material having a photosensitive group. A preferable form of the alignment layer will be mentioned later.

### (Depressed Portion Defect)

Examples of defects which may occur on the glass substrate include a flaw or dent, or contamination of air bubbles or foreign matter. A flaw or dent may be formed on the surface of the glass substrates by contact therebetween when the glass substrates are cut out from a material plate, for example. In Embodiment 1, a flaw or dent is formed on the glass substrate at the surface opposite to the liquid crystal layer (outside) and such a defect portion of the glass substrate is shaved off with respect to the liquid crystal display panel, so that a depressed portion is formed. Examples of air bubbles or foreign matter contaminated in the glass substrate include those derived from glass materials and those derived from the external environment. Such air bubbles or foreign matter are commonly mixed in upon shaping glass substrates or material plates of glass substrates. Such air bubbles or foreign matter are difficult to be removed perfectly in the industrial level by the current technology.

If such a defect is found on the glass substrate of the display panel and the glass substrate with a defect is covered with a polarizer film (and a retardation film), the polarizer film (and the retardation film) is (are) detached from the glass substrate and the glass substrate with a defect is exposed. Then, a glass material around the defect is removed depending on the type of the defect. If the defect on the glass substrate 11 is air bubbles, for example, the glass material of the glass substrate 11 is removed from the outside surface to the air bubbles. If the defect on the glass substrate 11 is foreign matter, the foreign matter is also removed.

Removal of the glass material may be performed by grinding with a grindstone or wrapping grinding using a tape, for example. As the result of removal, a depressed portion is formed on the outside surface of the glass substrate. If necessary, the shape of the depressed portion may be arranged by shaving the glass material around air bubbles or a flaw.

The aforementioned restoring process for a glass substrate may be in a mode that the glass material is not removed. For example, the depressed portion may be a flaw on the surface of the glass substrate or may be air bubbles having an opening on the surface of the glass substrate.

### (Step of Filling Ultraviolet-Curable Resin)

As shown in FIG. 1, the liquid crystal display panel of Embodiment 1 has a depressed portion within the display area of the outside surface thereof. The depressed portion on the surface of the glass substrate is to be filled with an ultraviolet-curable resin.

The ultraviolet-curable resin may be one that has sufficient transparency required in the technical field and that may be cured by ultraviolet rays at 400 to 430 nm. Such an ultraviolet-curable resin can be obtained by appropriately adjusting the types and amounts of the materials in accordance with the common technical knowledge in the technical field of the present invention.

In Embodiment 1, a material substance which is a cross-linked (meth)acrylic resin is used as the ultraviolet-curable resin. Examples of such an ultraviolet-curable resin include commercial products such as WORLD ROCK No.8807LK (Kyoritsu Chemical & co., ltd.). WORLD ROCK No.8807LK includes a photo initiating material that absorbs ultraviolet rays at 430 nm or shorter, and such a photo initiating material is suitable for curing the ultraviolet-curable resin. Resins other than (meth)acrylic resin may be used as the ultraviolet-curable resin; still, (meth)acrylic resin is preferable owing to its properties such as transparency and weather resistance.

The liquid crystal display panel is placed such that the opening of the depressed portion of the glass substrate is upward vertically, and the depressed portion is filled with the ultraviolet-curable resin together with a photo initiator (photo-polymerization initiator) which absorbs ultraviolet rays at 430 nm or shorter and which is dissolved in an organic solvent or a material substance. The components may be filled after mixing, or the compounds may be filled one by one.

Specific examples of the ultraviolet-curable resin ((meth) acrylic resin) will be described in detail below. The ultraviolet-curable resin in the glass substrate for a liquid crystal display panel preferably has high transmittance and low birefringence.

In the case that the ultraviolet-curable resin is a cross-linked (meth)acrylic resin, the (meth)acrylic resin is preferably one obtainable by copolymerizing two or more material substances, for example, one obtainable by random-copolymerization of a cross-linker and a material substance comprising a monomer or oligomer of a (meth)acrylic acid ester. Specific examples of the cross-linked (meth)acrylic resin to be used include a cross-linked polymethyl methacrylate (PMMA) resin. This leads to suppressed optical anisotropy and low birefringence of the (meth)acrylic resin.

For example, the material substances of the (meth) acrylic resin to be used are preferably a modified acrylate oligomer (e.g. an oligomer of an acrylic acid ester) and an ultraviolet-reactive monomer (e.g. diacrylate for cross-linking). Then, mixing of these material substances and radical-polymerization of these substances in the presence of a photo initiator provide a radical-polymerizable (meth)acrylic resin consisting of these material substances randomly copolymerized with each other. This (meth)acrylic resin has a cross-linked net structure. The present invention may be in a form that one material substance is polymerized (a cross-linker is not used) or may be in a form that two or more material substances are copolymerized. In the case of a self-cross-linkable (meth)acrylic monomer or oligomer, for example, a cross-linker may not be used. Still, copolymerization of two or more material substances as mentioned above is more preferable than copolymerization of one material substance because copolymerization of two or more material substances provides more suppressed optical anisotropy of a (meth)acrylic resin to be obtained.

Particularly preferable is a form that a material substance comprising an oligomer of a (meth) acrylic acid ester is randomly copolymerized with a cross-linker.

Preferably, the material substance of the (meth)acrylic resin has no benzene ring structure and the cross-linked (meth)acrylic resin has no benzene ring structure.

Examples of such a (meth)acrylic acid ester include (meth) acrylic acid alkyl esters such as methyl (meth)acrylate, ethyl (meth)acrylate, n-propyl (meth)acrylate, n-butyl (meth)acrylate, isobutyl (meth)acrylate, t-butyl (meth)acrylate, 2-ethylhexyl (meth)acrylate, and lauryl (meth)acrylate; (meth)acrylic acid cycloalkyl esters such as cyclohexyl (meth)acrylate; and basic (meth) acrylic acid esters such as dimethylaminoethyl (meth)acrylate and diethylaminoethyl (meth)acrylate. Each of these may be used alone, or two or more of these may be used in admixture as appropriate.

A cross-linker such as a cross-linkable monomer is used as the cross-linker. The cross-linker may be a compound having two or more functional group which is reactive with a functional group in the compound to be cross-linked such as an oligomer of a (meth)acrylic acid ester. Examples thereof include polyfunctional (meth)acrylates such as ethylene glycol di(meth)acrylate, diethylene glycol di(meth)acrylate, propylene glycol di(meth)acrylate, dipropylene glycol di(meth)acrylate, neopentyl glycol di(meth)acrylate, trimethylolpropane tri(meth)acrylate, and pentaerythritol tetra(meth)acrylate; and epoxy (meth)acrylates, as well as divinyl benzene, diallyl phthalate, diallyl isophthalate, triallyl cyanurate, and triallyl isocyanurate.

Examples of the photo initiator include a photo initiating material contained in WORLD ROCK No.8807LK (trade name, Kyoritsu Chemical & co., ltd.) which is a commercial product. In the technical field of the present invention, it is sufficiently recognized that there are materials that initiate within a visible-light range (430 nm or shorter, preferably 400 nm or longer and 430 nm or shorter) other than the photo initiating material contained in WORLD ROCK No. 8807LK. These materials may be appropriately used.

The above cross-linked (meth)acrylic resin may be a polymer obtained by polymerizing one material substance, or may be one for copolymerizing two or more material substances. Copolymerization of two or more material substances is more preferable from the viewpoint of optical anisotropy.

In synthesis of the ultraviolet-curable resin consisting of the (meth)acrylic resin cross-linked by polymerizing the above material substances, additives such as a silane coupling agent and an antioxidant may be added. Further, a photo initiator that absorbs light with a wavelength of 430 nm or shorter improves the transparency of the ultraviolet-curable resin after curing, and thereby a high-quality glass substrate can be obtained. More preferably, the photo initiator is in a form that it substantially does not absorb light at longer than 430 nm.

### (Light-Curing Step)

As shown in FIG. 1 and FIG. 2, the depressed portion within the display area on the outside surface of a liquid crystal display panel is filled with an ultraviolet-curable resin and the ultraviolet-curable resin is light-cured by ultraviolet rays 51, so that the depressed portion is filled with a cured product of the ultraviolet-curable resin 41 and restored. The ultraviolet rays may be ultraviolet rays at 400 to 430 nm.

FIG. 3 shows a graph of the wavelength range of a Hg—Xe lamp used in Embodiment 1.

In FIG. 3, LC-8 (trade name, light source: 200 W Type LC8-01, reflector: 365 nm Type, lamp: Hg—Xe lamp L8251, light guide: diameter 5 mm to 1 mm Type A10014-50-0110, Hamamatsu Photonics K.K.) is used as an irradiator.

In Embodiment 1, light is applied to the inside of the depressed portion from LC8-06 (trade name, 200 W Type, Hamamatsu Photonics K.K, also referred to as a 06-type light source), which is a Hg—Xe lamp, through a cut filter which cuts light with a wavelength shorter than 400 nm (similar to conventional filters, a filter that cuts light with a wavelength to 365 nm (i-line rays), also referred to as a 09-type filter). As a result, curing can be performed by light within a wavelength range 61 to be used for curing which is obtained by subtracting a wavelength range 65 which causes a damage on a panel (alignment layer formed from a material having a photosensitive group) from a wavelength range 63 which the photo initiator of the resin absorbs.

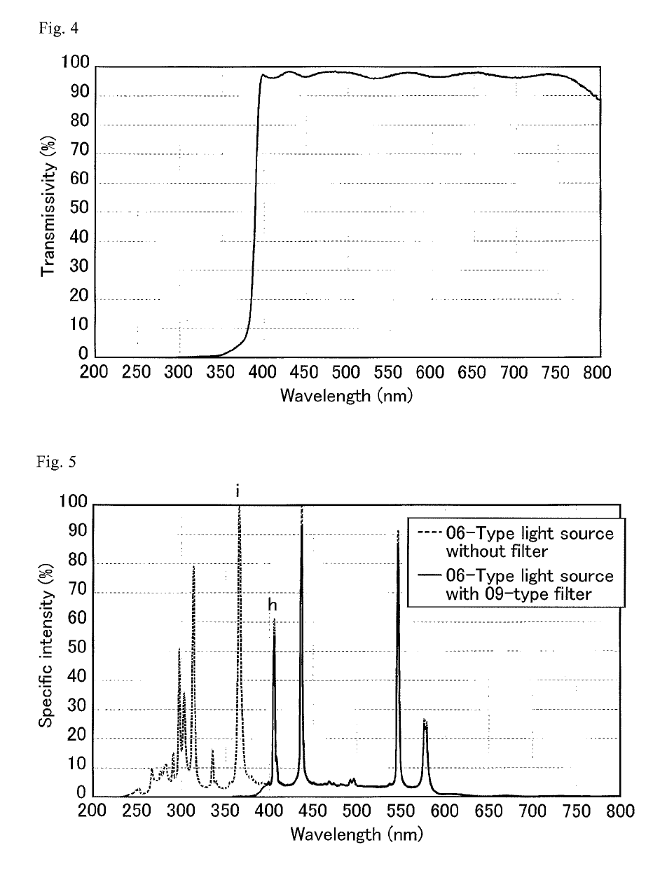

FIG. 4 shows a graph of the spectrum of a cut filter used in Embodiment 1. FIG. 5 shows a graph of the spectrum of a Hg—Xe lamp together with a cut filter and a graph of the spectrum of a Hg—Xe lamp without a cut filter in Embodiment 1. The alignment layer formed from a material having a photosensitive group is highly sensitive to the i-line rays. Thus, the specific intensity of the i-line rays is preferably 50% or lower of the specific intensity of the h-line rays. It is more preferably 30% or lower, and further preferably 10% or lower. Furthermore, the cut filter preferably blocks the light (i-line rays) substantially perfectly. In FIG. 5, the light is blocked to the extent that the light is considered to be substantially perfectly blocked owing to the cut filter (09-type filter) used in Embodiment 1. FIG. 4 shows the case that a cut filter A-7028-09 (trade name, Hamamatsu Photonics K.K.) or A-9616-09 (trade name, Hamamatsu Photonics K.K.) is used. In FIG. 5, LC-8 (trade name, light source: 200 W Type LC8-06, reflector: 546 nm Type, lamp: Hg—Xe lamp L8251, filter: A9616-09, light guide: diameter 5 mm to 1 mm Type A10014-50-0110, Hamamatsu Photonics K.K.) is used as an irradiator.

Application of light including the i-line rays affects the alignment if the light exceeds 8,000 mJ, for example. If the i-line rays are cut by the filter of Embodiment 1, however, the light does not affect the alignment layer until the application reaches 44,000 mJ. As mentioned here, optimum selection of the wavelength of the ultraviolet rays enables to preferably correct a defect in Embodiment 1. In other words, the wavelength needs to be 400 nm or longer in order not to affect the alignment layer, and the resin is preferably one which is cured by light with a wavelength of 430 nm or shorter so as not to be colored. Application itself of light with a wavelength of 430 nm or shorter in the light-curing step is not prohibited, and such application may be performed. An ultraviolet application device that specifically and strongly emits ultraviolet rays within a predetermined wavelength range may be used, and such a device also can exert similar effects.

The following will describe preferable forms of the aforementioned alignment layer. Preferable as the form of each of the alignment layers 12 and 22 are as follows, for example: (1) a form that a substantially uniform pre-tilt angle is given to each liquid crystal molecule near the alignment layer; (2) a form that the pre-tilt angle of each liquid crystal molecule near the alignment layer is 89° or smaller; (3) a form that the alignment layer is a photo-alignment layer formed from a material having at least one photosensitive group selected from the group consisting of a 4-chalcone group, a 4′-chalcone group, a coumarin group, and a cinnamoyl group; and (4) a form that the alignment layer has at least one structure selected from the group consisting of a coupling structure, a photoisomerization structure, and an optical re-alignment structure of a photosensitive group.

The form (1) enables to effectively suppress variations in the pre-tilt angle and to easily achieve stable transmissivity in a VATN-mode liquid crystal display device. The term “substantially uniform” in the form (1) does not mean that the pre-tilt angles are strictly uniform, but means that they are uniform to the extent that the above effects are exerted. Even in a VATN mode, the form (2) can provide a liquid crystal display device having transmissivity as high as that of a VAECB mode. In the form (3), the photosensitive group causes reactions by light such as cross-linking reaction (including dimerization reaction), isomerization reaction, and optical re-alignment. As a result, variations in the pre-tilt angle may be effectively suppressed and a VATN-mode liquid crystal display device having stable transmissivity can be provided. The material having a photosensitive group (photosensitive material) is preferably a material that causes photo-coupling reaction (photo-coupling material), and the alignment layer of the present embodiment is preferably a photo-coupling alignment layer. The form (4) is also one preferable form that effectively suppresses variations in the pre-tilt angle and can provide a VATN-mode liquid crystal display device having stable transmissivity. The coupling structure of the photosensitive group in the form (4) means a structure that the photosensitive functional groups contained in the structural molecules of the photosensitive material are coupled to each other by light application. The coupling structure of the photosensitive group is preferably one formed by cross-linking reaction. In this case, the coupling structure can be formed by applying light with a wavelength of 250 to 400 nm, for example. The cross-linking reaction means a reaction in which chemical bonds are formed between some specific atoms in linear polymers, and it includes dimerization reaction. The photosensitive material generally has a molecular structure that multiple side chains are coupled to a linear main chain and the side chains have a photosensitive group (photo-reactive group). Thus, in the photosensitive material, cross-linking reaction such as dimerization reaction of the photosensitive group occurs between two side chains by light application, so that a cross-linking structure is formed. Asa result, the alignment layer of the present invention has a coupling structure of the photosensitive group.

In the light-curing step, light is applied and, if necessary, heat treatment is performed, so that the material substance in the depressed portion is polymerized. At this time, the polymerization reaction is initiated and accelerated by light energy and the like, and thereby a cured ultraviolet-curable resin (also referred to as a cured product of the ultraviolet-curable resin) is formed. The conditions in the curing step (intensity, time, and the like of light application) are preferably appropriately adjusted depending on the types of the ultraviolet-curable resin and photo initiator to be used for synthesis.

After the ultraviolet-curable resin is sufficiently cured, the surface of the ultraviolet-curable resin is generally ground so as to be flat.

As mentioned above, the process for producing a liquid crystal display panel of Embodiment 1 has a constitution that the depressed portion on the surface of the glass substrate 11 is filled with the ultraviolet-curable resin comprising a cross-linked (meth)acrylic resin. Specifically, the process has a constitution that the depressed portion is filled with the material substance which is a structural element of the ultraviolet-curable resin together with a photo initiator which absorbs ultraviolet rays with a wavelength of 430 nm or shorter, and then the filled material substance and photo initiator is irradiated with ultraviolet rays with a wavelength of 400 nm or longer and 430 nm or shorter and, if necessary, subjected to heat treatment, so that the polymerization reaction is allowed to proceed in the depressed portion, and a cured product of an ultraviolet-curable resin obtained as the result of the polymerization reaction fills the depressed portion. As mentioned here, use of an ultraviolet-curable resin as a material for filling the depressed portion enables to sufficiently prevent a damage on the alignment layer, as well as to restore the glass substrate 11 at a temperature lower than that in firing treatment.

In the above constitution, photo polymerization is used for polymerization of the material substance. Thus, the temperature of heating treatment required for polymerization can be lowered, or the heating treatment may be excluded in some cases. As a result, a change in the volume of the material substance by thermal expansion can be suppressed and generation of bubbles in the ultraviolet-curable resin can be suppressed.

The light curing step in the process of producing a glass substrate of Embodiment 1 may be performed in any stage in the process for producing a liquid crystal display panel. For example, the present invention can be applied to a stage before a glass substrate is assembled into a liquid crystal display panel, a stage after the assembled liquid crystal display panel is checked and before it is assembled into a liquid crystal display device, and the like. In relation to the problem of the present invention, the effects of the present invention can be exerted by performing light curing in the case that an alignment layer is formed on a substrate, in general.

When a glass substrate is not assembled into a liquid crystal display panel and an alignment layer is disposed on a glass substrate, the process for producing a liquid crystal display panel of Embodiment 1 can, for example, restore the glass substrate without removing the alignment layer on the substrate opposite to the side where the depressed portion is formed. Even after a defected glass substrate is assembled into a liquid crystal display panel, the glass substrate 11 can be restored without decomposing the display panel. Such a simplified production process leads to an extremely good effect in the industrial context.

### Comparative Example 1

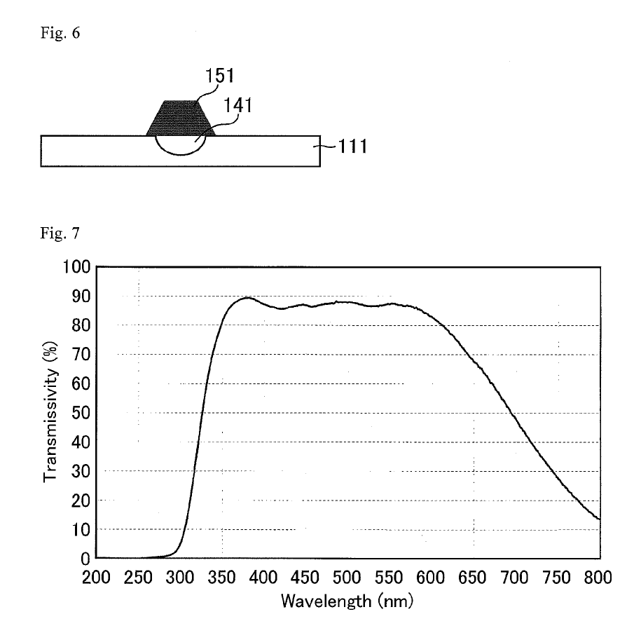

FIG. 6 is a view showing a step of applying ultraviolet rays in Comparative Example 1.

FIG. 7 is a graph showing a spectrum (transmissivity curve) of a cut filter of Comparative Example 1. In the case of combining the above Hg—Xe lamp with a cut filter (a filter that can cut light with a wavelength to h-line rays; also referred to as a 08 filter) of Comparative Example 1, the alignment layer was damaged and display performance was poor. In FIG. 7, a cut filter A-7028-08 (trade name, Hamamatsu Photonics K.K.) or a cut filter A-9616-08 (trade name, Hamamatsu Photonics K.K.) was used.

The above examples each describe a liquid crystal display panel, and such forms in which a display panel is a liquid crystal display panel are preferable forms of the present invention. In addition, the present invention also can be applied to other display panels (e.g. plasma display panel) having a functional film formed from a material having a photosensitive group.

The aforementioned forms of the embodiments may be employed in appropriate combination as long as the combination is not beyond the spirit of the present invention.

The present application claims priority to Patent Application No. 2010-056579 filed in Japan on Mar. 12, 2010 under the Paris Convention and provisions of national law in a designated State, the entire contents of which are hereby incorporated by reference.

### REFERENCE SIGNS LIST

11, 21: glass substrate
12, 22: alignment layer
31: liquid crystal material
41: cured product of an ultraviolet-curable resin
51: ultraviolet rays (405 nm)
61: wavelength range used for curing
63: wavelength range absorbed by photo initiator of resin
65: wavelength range where panel is damaged

1. A display panel, comprising:
a pair of substrates;
a display element disposed between the substrates; and
a functional film disposed on a surface facing the display element of at least one of the substrates,
the functional film being formed from a material having a photosensitive group,
at least one of the substrates having a depressed portion on its surface and the depressed portion being filled with a cured product of an ultraviolet-curable resin, and
the cured product having been formed by curing the ultraviolet-curable resin with ultraviolet rays at a wavelength of 400 nm or longer.

2. The display panel according to claim 1,
wherein the cured product is formed by curing the ultraviolet-curable resin with ultraviolet rays at a wavelength of 430 nm or shorter.

3. The display panel according to claim 1,
wherein the ultraviolet-curable resin is a resin composition containing a photo initiator that absorbs ultraviolet rays at a wavelength of 430 nm or shorter.

4. The display panel according to claim 1,
wherein the display element is a liquid crystal layer and the functional film is an alignment layer.

5. A process for producing a display panel comprising a pair of substrates, a display element disposed between the substrates, and a functional film disposed on a surface facing the display element of at least one of the substrates, wherein the functional film is formed from a material having a photosensitive group, and at least one of the substrates has a depressed portion on its surface, the method comprising the steps of:
filling an ultraviolet-curable resin into the depressed portion; and
light-curing the ultraviolet-curable resin by applying ultraviolet rays at a wavelength of 400 nm or longer to the resin.

6. The process for producing a display panel according to claim 5,
wherein, in the light-curing step, the ultraviolet-curable resin is irradiated with ultraviolet rays at a wavelength of 430 nm or shorter to be cured.

7. The process for producing a display panel according to claim 5,
wherein, in the light-curing step, i-line rays of the ultraviolet rays applied to the ultraviolet-curable resin are blocked.

8. The process for producing a display panel according to claim 5,
wherein, in the light-curing step, h-line rays are applied to the ultraviolet-curable resin.

9. The process for producing a display panel according to claim 5,
wherein the display element is a liquid crystal layer and the functional film is an alignment layer.
